(19) United States
(12) Patent Application Publication
(10) Pub. No.: US 2025/0120410 A1
(43) Pub. Date: Apr. 17, 2025

(54) AUTONOMOUS ROBOTIC BONE DUST SCRAPER

(71) Applicant: ALTITUDE ROBOTS, INC. DBA ALTITUDE AI, Salt Lake City, UT (US)

(72) Inventors: Edward WALKER, Salt Lake City, UT (US); Kye ELLIOTT, Midvale, UT (US); Alexander KHAN, Salt Lake City, UT (US)

(21) Appl. No.: 18/379,493

(22) Filed: Oct. 12, 2023

(51) Int. Cl. A22C 17/00; B08B 1/16; B08B 1/20; B08B 1/52

(52) U.S. Cl. CPC A22C 17/004; A22C 17/0086; B08B 1/165; B08B 1/20; B08B 1/52

(57) ABSTRACT

Scraping bone dust off of pieces of meat may be performed using a sensor camera, a computing system, and a robotic arm equipped with a scraper. The camera may provide images of a piece of meat that may be processed in the computing system, either alone or in combination with the sensor camera, to determine how to control the robotic arm. A pair of bone scraping systems may be used in combination with a flipping device disposed between them to enable bone dust scraping from both sides of the piece of meat.

### FIELD OF ENDEAVOR

Aspects of the present disclosure may relate to a robotic system for scraping bone dust off of meat.

### BACKGROUND

After meat is cut, inedible bone particles (“bone dust”) typically adhere to the meat and need to be scraped off before the meat is fit to be packaged for consumption.

Two primary solutions exist to perform this task. One solution is for human workers to perform bone dust scraping. In this method, a worker uses a bone dust scraper to scrape bone dust from one side of a piece of meat, flips the meat, and scrapes bone dust from the other side of the meat, as the meat is moved conveyed along, e.g., by a conveyor belt. However, the meat processing industry may suffer from labor shortages, high levels of turnover, and absenteeism, in addition to worker inattentiveness (e.g., but not limited to, due to the repetitive nature of the task). As a result, manual scraping may suffer from reliability issues.

The other primary method that may be used is a machine-based solution. However, current scraping machines, such as the Meat Scraping System manufactured by Midwest Machines, require a large amount of space and are self-contained. Therefore, such a machine may not be fully integrable with the rest of the meat processing system, requiring the meat processing system to be specially designed or reconfigured to accommodate such a machine, or possibly, even to need human intervention to interface with the rest of the meat processing system.

It would, therefore, be desirable to provide a bone scraping method that is automated, food-safe, reliable, accurate, fast, and fully integrable within a meat processing line.

### SUMMARY OF THE DISCLOSURE

The above goals may be achieved by means of a bone scraping system according to aspects of the present disclosure. According to one aspect of the present disclosure, an autonomous robotic bone dust scraping system may be provided. The system may utilize two-dimensional (2-D) and/or three-dimensional (3-D) computer vision to guide a robotic arm that may be equipped with a scraping tool to scrape bone dust from pieces of meat. In a system, two such robotic arms may be employed, in which the computer vision system may be used to locate a piece of meat on a conveyor belt that conveys the meat and whose output may be used to guide the first robotic arm to scrape bone dust from a first side of the piece of meat, after which the piece of meat may be flipped onto a second conveyor belt that may convey the meat past the second robotic arm, which may be controlled (again using output of a computer vision system, which may be the same system or a different system) to scrape bone dust from the other side of the piece of meat. The computer vision system(s) may be communicatively coupled to a computer, and the computer may provide commands to control the robotic arms. A graphical user interface (GUI) may allow a human operator to initiate and/or otherwise control operation of the system.

According to a further aspect of the present disclosure, a method of performing bone dust scraping using one or more robotic arms may be provided. The method may involve using 2-D and/or 3-D computer vision to identify pieces of meat approaching on a conveyor apparatus, such as a conveyor belt, and controlling one or more robotic arms to perform bone dust scraping.

According to yet a further aspect of the present disclosure, a non-transitory computer-readable medium may contain executable code that results in implementation of the described method.

### BRIEF DESCRIPTION OF ACCOMPANYING DRAWINGS

Various aspects of this disclosure will now be discussed in further detail in conjunction with the attached drawings, in which:

FIG. 1 shows a conceptual block diagram of a meat processing system that may incorporate aspects of the present disclosure;

FIG. 2 shows a conceptual block diagram of an example of a bone scraping system according to aspects of the present disclosure;

FIG. 3 shows a conceptual example of a bone dust scraper according to aspects of the present disclosure;

FIGS. 4A and 4B show conceptual examples of component units that may be used to implement bone dust scraping according to aspects of the present disclosure;

FIG. 5 shows a conceptual block diagram of a sub-system according to further aspects of the present disclosure;

FIG. 6 shows a conceptual example of a network configuration according to various aspects of the present disclosure;

FIG. 7 shows a conceptual example of a user interface according to various aspects of the present disclosure;

FIG. 8 shows an example of a flowchart of a method according to various aspects of the present disclosure;

FIG. 9 shows a detailed example of a portion of the flowchart of FIG. 8, according to various aspects of the present disclosure;

FIG. 10 shows an example of spaced paths determined during a bone dust scraping process according to various aspects of the present disclosure;

FIG. 11 shows an example flowchart of a further method according to aspects of the present disclosure; and

FIGS. 12A-12D show example conceptual diagrams of implementations of a component of a system according to various aspects of the present disclosure.

### DETAILED DESCRIPTION OF ASPECTS OF THE DISCLOSURE

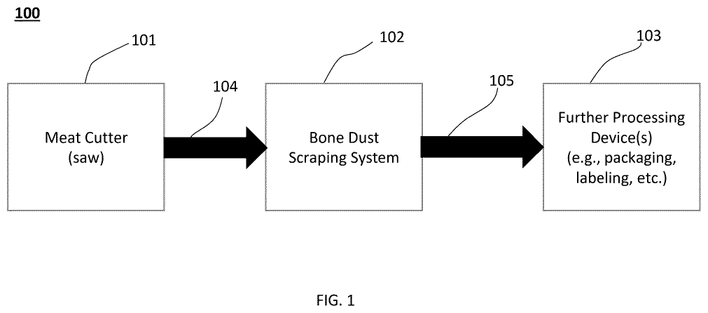

FIG. 1 shows a conceptual block diagram of a meat processing system 100 that may incorporate bone dust scraping. Pieces of meat may be cut from larger portions of slaughtered animal using a meat cutter 101, e.g., in the form of a saw. A given portion of a slaughtered animal may incorporate one or more bones, and as a result, cutting the portion into pieces of meat may result in bone dust accumulation on one or more surfaces of the cut pieces of meat; typically, the bone dust accumulates on the sides of the meat that were created by the cutting action of the meat cutter 101 (e.g., the sides of the piece of meat that were created by action of a saw). The resulting pieces of meat may be conveyed 104 to a bone dust scraping system 102. This may be by means of a direct conveyor system 104, e.g., one or more conveyor belts, from the meat cutter 101 to the bone dust scraping system 102, or the cut pieces of meat may need to be loaded onto a conveyor system 104 into the bone dust scraping system 102 (e.g., human workers may need to remove the cut pieces of meat from the meat cutter 101 and place them onto an input conveyor 104 into the bone dust scraping system 102). The bone dust scraping system 102 may then remove bone dust from both sides of each piece of meat that is conveyed into the bone dust scraping system 102. The resulting “cleaned” pieces of meat may then be conveyed 105 out of the bone dust scraping system 102 to at least one further device for processing the meat (e.g., a packager, labeler, or other meat processing device).

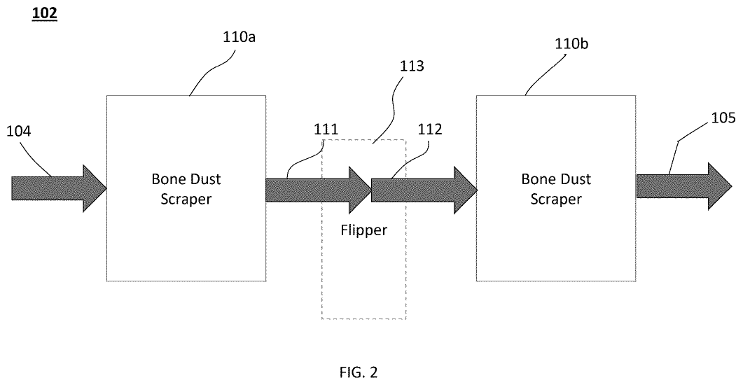

FIG. 2 presents a conceptual block diagram of how bone dust scraping system 102 may be implemented. As discussed above, both sides of a piece of meat may need to be cleaned of bone dust. Accordingly, bone dust scraping system may be implemented using two bone dust scrapers 110a, 110b. Cut pieces of meat may be conveyed 104 into a first bone dust scraper 110a, which may scrape bone dust from a first side of each piece of meat and may output each piece of meat thus cleaned to be conveyed 111, 112 to a second bone dust scraper 110b, which may then scrape bone dust from the other side of each piece of meat, and which may then convey 105 the thus-cleaned pieces of meat for further processing.

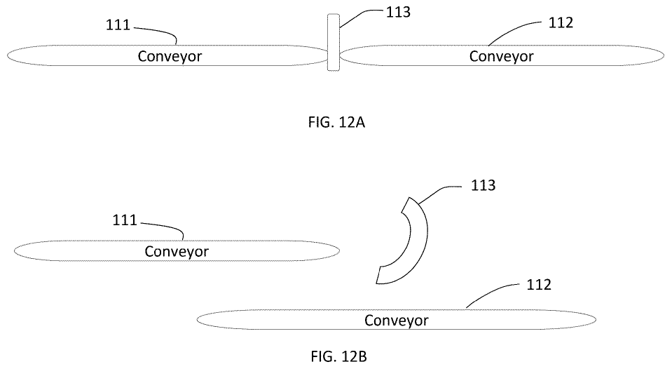

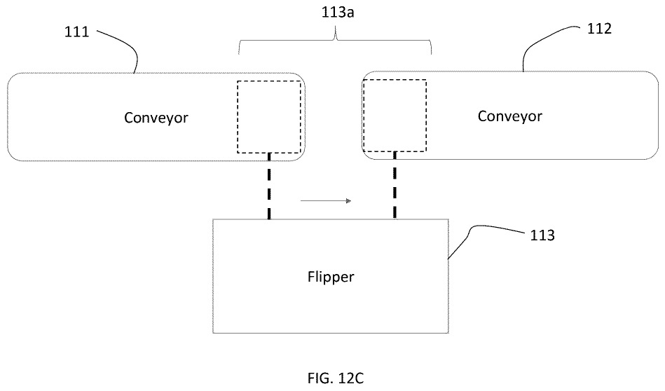

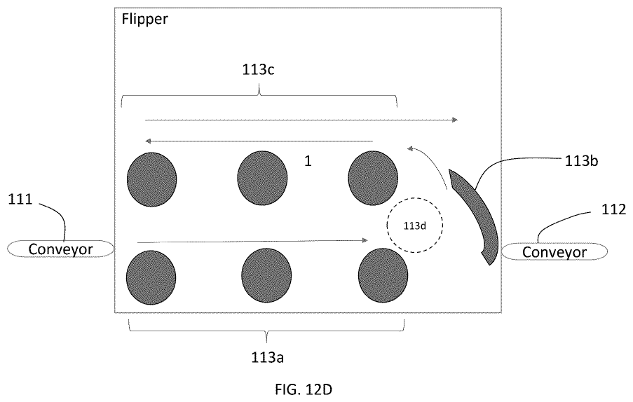

As part of the process and apparatus of FIG. 2 following the first bone dust scraper 110a, the piece of meat may be flipped before it enters the second bone dust scraper 110b to remove bone dust from what was initially the underside of the piece of meat. There are a number of ways in which this may be performed. According to one aspect of the present disclosure, conveying the meat between the first bone dust scraper 110a and the second bone dust scraper 110b may involve two conveyor systems 111, 112 (e.g., but not limited to conveyor belts) that may be arranged such that each piece of meat is flipped. This may involve the use of a flipper 113, which may take many different forms. For example, as shown in FIG. 12A, flipper 113 may be a ridge or other upward projection that may disrupt the conveyance of the piece of meat on conveyor 111 such that a leading edge of each piece of meat impacts against the flipper 113, and the momentum imparted to the piece of meat by the conveyor 111 causes it to flip over the flipper 113 onto conveyor 112; this may also be used in a system in which conveyors 111 and 112 are a single conveyor, in which this type of flipper 113 is disposed along and just above the single conveyor. In a second example, as shown in FIG. 12B, conveyor 112 may be disposed at a vertical level below conveyor 111 such that when a piece of meat reaches the end of conveyor 111 with insufficient momentum to cause it to “fly flat” onto the second conveyor 112, it flips over onto conveyor 112; a guide, which may act as flipper 113, may be provided to ensure that the piece of meat flips before it lands on the second conveyor 112. In a third example, and example of which is shown in FIG. 12C, flipper 113 may be a device that detects and flips each piece of meat as it passes along or through flipper 113. In this case, conveyors 111, 112 may be either a single, continuous conveyor or two separate conveyors. Flipper 113 may include a spatula-like device or fork-like device 113a, which may be computer-controlled and/or may be fitted on a robotic arm, and which may flip the piece of meat (as shown in FIG. 12C, if there are two conveyors 111,112, this may involve flipping the piece of meat so as to convey it from conveyor 111 to conveyor 112). Alternatively, flipper 113 may take the form of a device situated between conveyors 111 and 112 and containing, e.g., one or more rollers that serve to flip the piece of meat received on conveyor 111 and output it onto conveyor 112. A non-limiting example of such an arrangement is shown in FIG. 12D, in which a piece of meat may be conveyed by conveyor 111 into flipper 113, onto a first set of rollers 113a. The first set of rollers 113a may convey the piece of meat to a guide 113b, which directs the piece of meat onto a second set of rollers 113c; this may be assisted by one or more guide rollers 113d, which may be optional. Once the piece of meat has been conveyed onto the second set of rollers 113c, the second set of rollers 113c may reverse direction to convey the piece of meat onto conveyor 112; this may be involve using an outer side of guide 113b to guide the piece of meat onto conveyor 112.

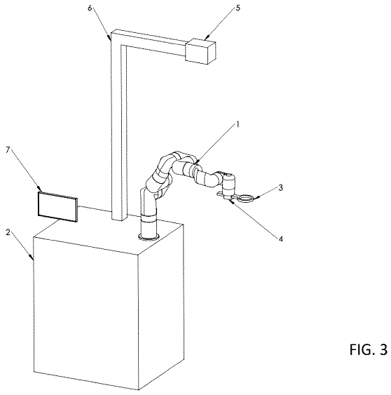

FIG. 3 shows a conceptual diagram of an example of a bone dust scraper 110x (i.e., 110a or 110b), according to aspects of the present disclosure. A robotic arm 1 may be mounted on a pedestal cabinet 2. Pedestal cabinet 2 may be used to enclose a computer and may, for example, be constructed of stainless steel. A bone scraper 3 may be removably attached to robotic arm 1 using a mount 4, which may be a stainless-steel mount. Although not shown, in order to more clearly show robotic arm 1, robotic arm 1 may be covered in a sleeve made of a food-safe fabric. A sensor camera 5 may be mounted on a mount 6, which may, for example, be crafted of stainless steel. Sensor camera 5 may be vertically offset from the top of cabinet 2, and the mount 6 may enable sensor camera 5 to have a field of view that includes pieces of meat as they enter and/or pass through bone dust scraper 110x. A computer (not shown) within cabinet 2 may be communicatively coupled with sensor camera 5 and robotic arm 1 to obtain image information from sensor camera 5 and to process the image information to determine control signals to provide to robotic arm 1. The computer may be coupled to a user interface 7, which may be, e.g., but is not limited to, a touchscreen display.

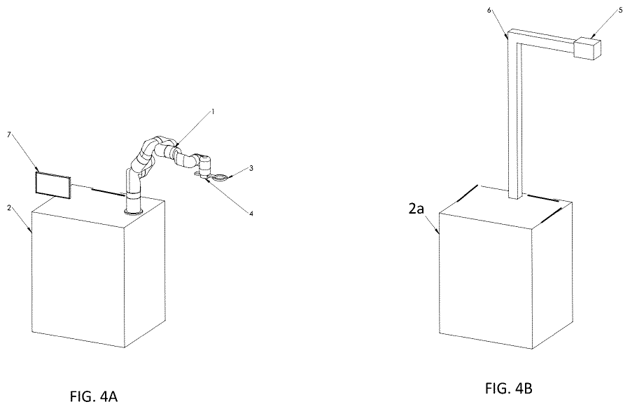

While FIG. 3 shows robotic arm 1 and sensor camera 5 mounted on a common cabinet 2, this is not the only possible implementation of the bone dust scrapers 110a. 110b. As shown in FIGS. 4A and 4B, the sensor camera 5 and the robotic arm 1 may be mounted separately, e.g., on respective pedestal cabinets 2 and 2a. In such a case, wired or wireless communications may be used to couple sensor camera 5 and robotic arm 1 to obtain image information and to provide control signals. Each of bone dust scrapers 110a, 110b may include its own computing system 120, or they may share a single computing system 120 (computing system 120 is described below). They may also have their own sensor cameras 1 or may share a sensor camera 1.

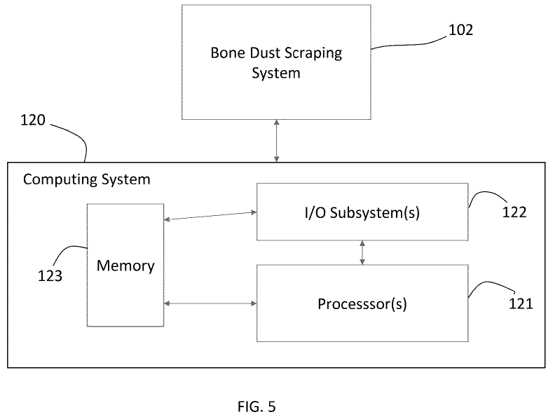

It is further noted that a computing system 120 may be provided locally to the bone dust scraping system/sub-systems or remotely from the bone dust scraping system, an example of the latter of which is shown in FIG. 5. Bone dust scraping system 102 may be communicatively coupled to a computing system 120 via wired and/or wireless communication channels. Computing system 120 may be located in a facility containing the meat processing system 100 of FIG. 1, or it may be one or more remote servers, connected via one or more communication networks, which may include the Internet. In the latter case, the computing system 120 may provide computing and control services for multiple meat processing systems 100, which may be located in multiple locations.

Computing system 120, whether located in a cabinet 2, locally in the meat-processing facility, or remotely located, may, for example, include one or more processors 121, which may be communicatively coupled to one or more memory devices 123, either or both of which may be communicatively coupled to one or more input/output (I/O) subsystems 122. User interface 7, as shown in FIGS. 3 and 4A, is an example of one I/O subsystem 122, but I/O subsystems 122 may include user interfaces other than a touchscreen display (e.g., mouse, keyboard, non-touchscreen display, speaker, microphone, etc.), one or more communication interfaces (e.g., transmitters, receivers, network cards, antennas, modems, etc.), and/or other such components. At least one non-transitory memory device of memory 123 may store executable instructions designed to be executed by the processor(s) 121 to cause the computing system 120 to implement various methods, such as image processing and robotic arm control, but which are not thus limited. Detailed examples of operations that may be thus implemented are discussed below.

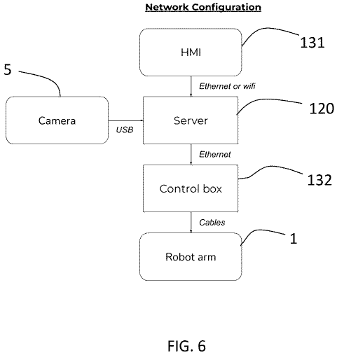

FIG. 6 shows a conceptual block diagram of a network configuration 130 according to an aspect of the present disclosure. Human-machine interface (HMI) 131 may be communicatively coupled to a computing system/server 120 and may comprise user interface 7. HMI 131 may be communicatively coupled to server 120 via an Ethernet® connection or WiFi® connection or via some other known connection. Sensor camera 5 may also be communicatively coupled to server 120, e.g., via a USB interface; however, the invention is not thus limited, and sensor camera 5 may be connected via a different type of interface. Robotic arm 1 may be directly controlled by an accompanying control box 132, which may be coupled to robotic arm 1 via one or more cables. The control box 132 may be communicatively coupled to server 120, which may provide control signals to the control box 132, which may then translate the control signals into commands for various components of robotic arm 1. Control box 132 may also provide feedback signal to server 120, e.g., to enable server 120 to fine-tune control of the robotic arm 1 and/or in case of a malfunction.

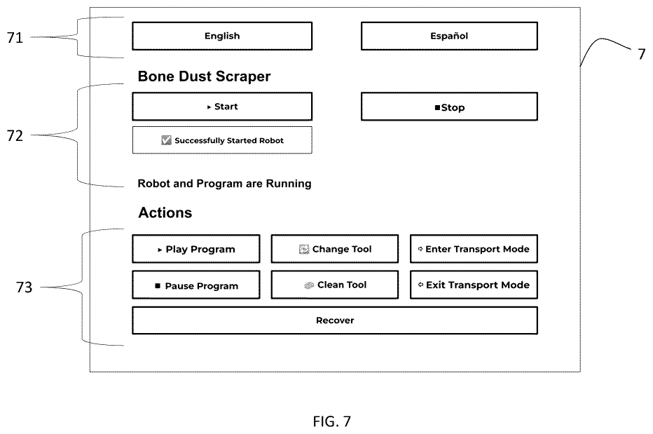

FIG. 7 shows a conceptual example of a user interface display 7, which may be a touchscreen display, but which is not thus limited. Display 7 may optionally offer the user a choice of two or more languages 71; however, the invention is not thus limited. Start/stop buttons, which may be touched or selected/clicked on by the user may be provided, and an accompanying display may show the system status 72. The user may also be provided with various choices of actions that may be taken 73.

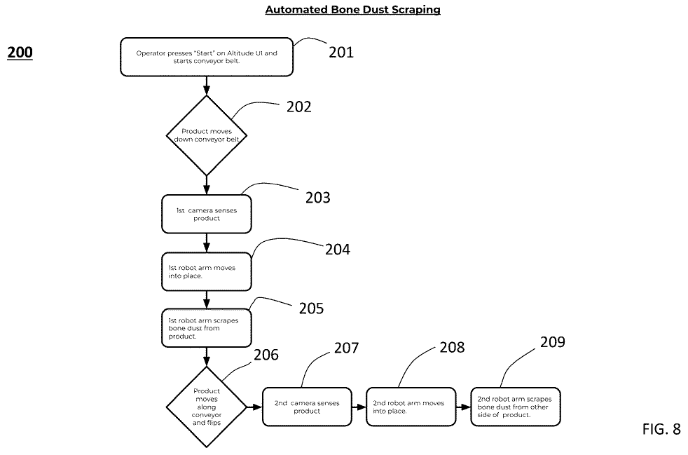

FIG. 8 shows a high-level flowchart 200 of operations according to aspects of the present disclosure. Operations may be initiated by a user causing the system to start 201, e.g., by pressing a “Start” button on user interface 7. Pieces of meat (“product”) may then be conveyed 202 into the bone dust scraping system 102. Considering the system configuration discussed above that includes two bone dust scrapers 110a. 110b in a configuration in which each bone dust scraper is associated with a sensor camera 5, a first sensor camera 5 provide image data for the product on the conveyor 104, and the image data may be conveyed to computing system 120 and processed to detect the presence of the product 203. Computing system 120 may provide control signals to control box 132 to move robotic arm 1 into place for operating on the product 204. When computing system 120 detects from sensor camera 5 that the product is in place for scraping, further control signals may be provided to control box 132 to cause robotic arm 1 to perform bone dust scraping 205 on a first side of the product. The product is then conveyed and flipped 206. A second sensor camera, associated with bone dust scraper 110b, may provide image data to computing system 120, which may use the image data to sense the presence of the product 207 in the second bone dust scraper 110b. Accordingly, the computing system 120 may provide control signals to the control box 132 of robotic arm 1 of bone dust scraper 110b to move robotic arm 1 into place for operating on the product 208. Once computer system 120 detects from sensor camera 5 that the product is in place for scraping, further control signals may be provided by computing system 120 to control box 132 to cause robotic arm 1 to perform bone dust scraping 209 on the other side of the product.

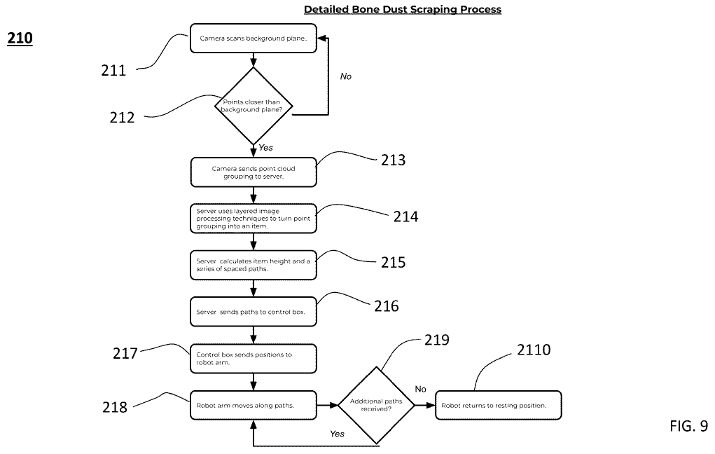

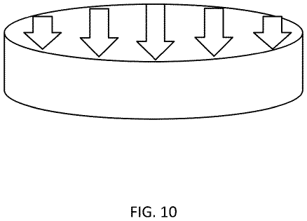

FIG. 9 shows an example 210 of how elements 203-205 or 207-209 of FIG. 8 may be implemented, according to aspects of the present disclosure. Sensor camera 5 may scan a background plane (e.g., the conveyor 104) 211 within a predetermined region, based on 3-D point cloud imaging. If sensor camera 5 detects that a point cloud image contains points above the background plane 212, the process continues to 213; otherwise, the process loops back to 211. In block 213, the sensor camera 5 may transmit a resulting point cloud grouping to computing system 120. The computing system 120 may then apply layered image processing techniques to the point cloud grouping 214 to create a 3-D item. Techniques used may include object segmentation, wherein the system may include a neural network trained on the color and depth data of the conveyor line as the product is conveyed. Other techniques, which may be used in combination with a neural network or instead, may include Gaussian derivative techniques (e.g., multi-scale Gaussian derivatives that may include a range of orders), local minimum and maximum intensity projections, and/or other known 2-D and/or 3-D image processing techniques. The computing system 120 may then, based on the resulting 3-D item, determine a height (thickness) of the item and a series of spaced paths 215, which may indicate positions to which scraper 3 would need to go to perform bone dust scraping; a conceptual example of this is shown in FIG. 10. The height and scraping paths of the item may be determined based on the z-values (i.e., perpendicular to the plane of the conveyor) and xy-values (i.e., along the plane of the conveyor), respectively, from the xyz points output by object segmentation. Spacing of the paths may be determined by using the dimensions of the scraper 3, which may result in a scraping of the complete surface of the item. The spaced paths and the height of the item may be transmitted 216 to the control box 132 of robotic arm 1. Control box 132 may then send the appropriate instructions 217, based on the paths and height, to robotic arm 1, which may then move along the paths 218, 219 until the paths have been traversed. Scraping may be performed while the piece of meat is stopped within the bone dust scraper or as the piece of meat progresses through the bone dust scraper. Following bone scraping, robotic arm 1 may return to its resting position 2110.

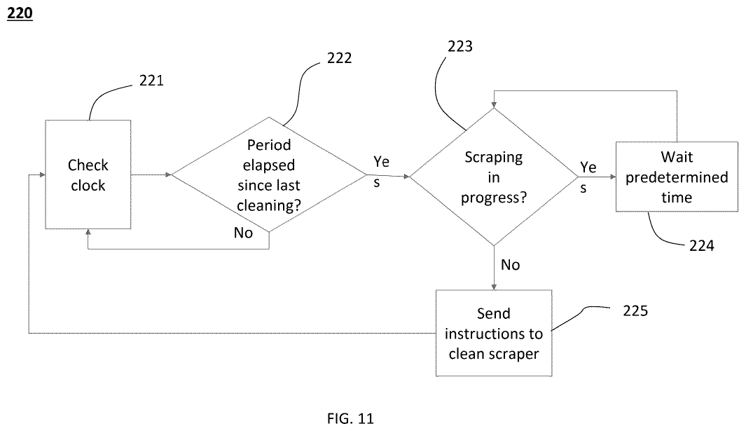

In addition to controlling the execution of bone dust scraping, computing system 120 may also control cleaning of the scraper 3. FIG. 11 shows an example of how this may be done. In FIG. 11, computing system 120 may check a timer or clock 221 and may determine 222 if a predetermined period has elapsed since a previous cleaning of the scraper 3. If the predetermined time period has not elapsed, the computing system 120 continues to monitor the timer/clock 221, 222. This monitoring 221, 222 may be performed at periodic intervals, for example, in which the value of the timer/clock may be compared with the next time at which cleaning should be scheduled or an expiration value of the timer (the latter may involve a countdown clock reaching zero or a count-up clock reaching a predetermined value, for example). When it is determined that the predetermined period since the last cleaning has elapsed 222, it may then be determined if bone dust scraping is in progress 223, which may prevent a bone dust scraping operation from being interrupted. If yes, then the system may wait a predetermined amount of time 224 and then re-check if bone dust scraping is in progress 223. If no, then computing system 120 may transmit instructions 225 to control box 132 to clean scraper 3, and the control box 132 may, in turn, control the robotic arm 1 to clean scraper 3. In a non-limiting example, this may be done by immersing and agitating scraper 3 in a cleaning solution or placing scraper 3 into a cleaning device. In a variation of this cleaning routine, computing system 120 may monitor the production of pieces of meat and may delay the next cleaning until there is a sufficiently large time period since the last time a piece of meat entered the bone dust scraper 110a, 110b to initiate cleaning of the scraper 3, to thus ensure that processing of an entire batch of pieces of meat is completed without missing any of the pieces of meat in the batch. In a further variation of this latter technique, computing system 120 may be able to control conveyor 104, either directly or by notifying an operator or another computing system (not shown), to delay a next batch of pieces of meat from being conveyed to first bone dust scraper 110a until cleaning has been completed.

Various aspects of the disclosure have been presented above. However, the invention is not intended to be limited to the specific aspects presented above, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

What is claimed is:

1. A bone dust scraping apparatus including:
a sensor camera disposed to obtain one or more images of a piece of meat from above the piece of meat as it is conveyed to and through the apparatus;
a computing device communicatively coupled to the sensor camera to receive and process the one or more images; and
a robotic arm system communicatively coupled to the computing device to receive control instructions from the computing device; and
a scraper coupled to the robotic arm system.

2. The bone dust scraping apparatus according to claim 1, wherein the robotic arm system includes a control box coupled to receive the control instructions; and a robotic arm coupled to the control box to receive control signals from the control box.

3. The bone dust scraping apparatus according to claim 1, wherein the sensor camera and the robotic arm system are mounted on separate bases.

4. The bone dust scraping apparatus according to claim 1, further including a user interface coupled to the computing device to enable a user to control operation of the bone dust scraping apparatus.

5. A bone dust scraping system including:
first and second bone dust scraping apparatus according to claim 1;
at least one conveyor disposed between the first and second bone dust scraping apparatuses; and
a flipper disposed between the first and second bone dust scraping apparatuses and along the at least one conveyor to flip a piece of meat from a first side to a second side between the first and second bone dust scraping apparatus.

6. A method of operating a bone dust scraping apparatus, the method including:
detecting a piece of meat approaching the bone dust scraping apparatus based on obtaining one or more images of the piece of meat as it is conveyed to the bone dust scraping apparatus;
processing the one or more images to determine one or more bone dust scraping paths and a height of the piece of meat; and
conveying instructions to a robotic arm system having a scraper mounted thereon to instruct the robotic arm to perform bone dust scraping on the piece of meat based on the height and bone dust scraping paths.

7. The method according to claim 6, wherein the one or more images comprise one or more point cloud images.

8. The method according to claim 7, wherein the processing the one or more images includes applying one or more layers of image processing techniques to convert the point cloud image into an item, wherein the one or more bone dust scraping paths are determined based on the item.

9. The method according to claim 6, wherein the detecting the piece of meat includes:
scanning a predetermined scanning region; and
detecting one or more points that are greater in height than other points in the scanning region.

10. The method according to claim 6, wherein the instructions further instruct the robotic arm to retract to a resting position after performing bone dust scraping.

11. The method according to claim 6, further including:
monitoring whether a predetermined period of time has elapsed since a previous cleaning; and
conveying instructions to the robotic arm system to clean the scraper.

12. A non-transitory computer-readable medium having executable code stored thereon designed to cause one or more processors to implement operations to perform the method according to claim 6.

13. A method of operating a bone dust scraping system, the method including:
performing the method according to claim 6 for a first bone dust scraping apparatus;
flipping the piece of meat from an initially upward directed side to an obverse side; and
performing the method according to claim 6 for a second bone dust scraping apparatus having a robotic arm distinct from a robotic arm of the first bone dust scraping apparatus.

14. A method of cleaning a bone dust scraping apparatus, the method including:
monitoring whether a predetermined period of time has elapsed since a previous cleaning; and
conveying instructions to a robotic arm of the bone dust scraping apparatus to clean a scraper mounted on the robotic arm.

15. The method of cleaning according to claim 14, further including monitoring production of pieces of meat and delaying cleaning to ensure that processing of an entire batch of pieces of meat is completed without missing any pieces of meat.

16. The method of cleaning according to claim 15, wherein delaying cleaning includes controlling a conveyor, either directly or by notifying an operator or another system, to delay a next batch of meat until cleaning has been completed.

17. The method of cleaning according to claim 14, wherein cleaning the scraper comprises:
immersing the scraper into a cleaning fluid; and
agitating the scraper.

18. A non-transitory computer-readable medium having executable code stored thereon designed to cause one or more processors to implement operations to perform the method according to claim 14.
